(19) United States
(12) Patent Application Publication
(10) Pub. No.: US 2007/0131965 A1
(43) Pub. Date: Jun. 14, 2007

(54) Triple-well low-voltage-triggered ESD protection device

(75) Inventors: Kwi Dong Kim, Daejeon (KR); Chong Ki Kwon, Daejeon (KR); Jong Dae Kim, Daejeon (KR); Young Seo Koo, Seoul (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/634,926

(22) Filed: Dec. 7, 2006

(30) Foreign Application Priority Data
Dec. 8, 2005 (KR) 2005-119535
Aug. 14, 2006 (KR) 2006-76773

(51) Int. Cl. H02H 9/00

(52) U.S. Cl. 257/173; 361/56

(57) ABSTRACT

An ESD protection device with a silicon controlled rectifier (SCR) structure which is applied to a nano-device-based high-speed I/O interface circuit and semiconductor substrate operated by a low power voltage. The triple-well low-voltage-triggered ESD protection device includes: a deep n-type well formed on a p-type substrate; n- and p-type wells formed to be mutually connected in the deep n-type well; and a bias application region for applying a direct bias voltage to the p-type well.

### CROSS-REFERENCE TO RELATED APPLICATION

This application claims priority to and the benefit of Korean Patent Application Nos. 2005-119535, filed Dec. 8 2005, and 2006-76773, filed Aug. 14, 2006, the disclosures of which are incorporated herein by reference in their entirety.

### BACKGROUND

1. Field of the Invention

The present invention relates to an electrostatic discharge (ESD) protection device for protecting an internal circuit from shock such as external static electric shock, etc. in semiconductor device technology, and more particularly, to an ESD protection device with a triple-well structure improved the shortcomings of a common silicon controlled rectifier (SCR) and a low-voltage-triggered SCR (LVTSCR) employed in a conventional ESD protection circuit.

2. Discussion of Related Art

ESD, the abrupt discharge of static electricity generated during the production and use of electrical devices and components, is becoming an important concern in the design of integrated circuits because it can cause the breakdown of an integrated circuit internal device and metal interconnections.

Particularly, as semiconductor manufacturing technology develops from a deep sub-micron (DSM) level to a very deep sub-micron (VDSM) level, a gate oxide layer is thinning down to 0.1 μm or less and a semiconductor chip is becoming smaller. Consequently, device breakdown caused by ESD is becoming a more serious problem. For this reason, it is very important to develop a protection device and design a circuit thereof that satisfy several ESD performance indicators such as rapid discharge speed, transparency in a normal operation state, sufficient robustness of discharge current, low trigger voltage effectiveness, etc.

The ESD protection devices with the SCR structure have a high ESD protection capability than general gate grounded NMOS (ggNMOS) or gate coupled NMOS (gcNMOS) protection devices. They also have a protection circuit with a minimized parasitic capacitance component due to its small area and thus are appropriate for today's faster and smaller semiconductor chips.

A common SCR illustrated in FIG. 2 has a much higher ESD protection capability than other generally used devices such as a ggNMOS. Thus, desired ESD protection capability can be obtained even with only a small area. And, since the parasitic capacitance component of the ESD protection circuit can be minimized, the SCR is suitable for a high-frequency analog or RF circuit. However, since the common SCR has a very high trigger voltage of about 30V, the gate oxide layer of a MOSFET in the internal circuit of a semiconductor chip may be destroyed or inner lines may be damaged due to the flow of ESD current before the protection circuit operates.

A conventional LVTSCR illustrated in FIG. 3 is designed to combine the advantages of the common SCR and the ggNMOS, and is triggered by n+ at a junction between an n-type well and a p-type substrate, and a breakdown voltage in the p-type substrate. It is as if the ggNMOS is disposed in the SCR structure, and thus the base width of a lateral npn transistor is minimized by channel width using the ggNMOS structure, thereby raising current gain and having a low trigger voltage. Also, a protection device with a trigger voltage of about 6V may be embodied by mininmizing the base width of a lateral pnp transistor of the SCR. While recent developments in VDSM process technology fuel the development and commercialization of products employing an I/O interface circuit and a semiconductor chip having a low power voltage of about 1.5V, the trigger voltage is still too high to apply the LVTSCR to high-speed, low-voltage VDSM-level circuits.

### SUMMARY OF THE INVENTION

The present invention is directed to an electrostatic discharge (ESD) protection device that can be applied to a semiconductor chip having high-speed and low-voltage characteristics.

The present invention is also directed to an ESD protection device that can minimize parasitic capacitance while operating with a low trigger voltage.

The present invention is also directed to an ESD protection device having a rapid response speed with respect to an ESD pulse.

One aspect of the present invention provides a triple-well low-voltage-triggered ESD protection device with a new structure for ESD protection formed by a deep well process which is one type of advanced CMOS process technology.

With the advancement of CMOS process technology to the VDSM level, innovative technologies are developing. The invention utilizes one such technology: triple-well process technology, which involves adding a deep n-type well process, not simply by applying n- and p-type well processes to a p-type substrate, and thus is extremely useful and enabling of expansion in circuit creation.

The triple-well low-voltage-triggered ESD protection device comprises: a deep n-type well formed on a p-type substrate; n-type and p-type wells formed to be mutually connected in the deep n-type well; and a bias application region for applying direct bias voltage to the p-type well.

The invention improves upon the high trigger voltage of a conventional ESD protection device, enabling faster response to an ESD pulse by connecting an RC network there to the ESD protection device, and thus is applicable to a high-speed, low-voltage integrated circuit designed and fabricated by VSDM processes. Particularly, the triple-well structure is formed by the deep-well process, which is advanced CMOS processing technology, thereby directly applying bias to the p-type well region where the SCR is triggered. As a result, the ESD protection device has a much lower trigger voltage than conventional devices.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a cross-sectional view of an electrostatic discharge (ESD) protection device having a silicon controlled rectifier (SCR) structure with a low trigger voltage by a triple-well process according to an exemplary embodiment of the invention;

FIG. 2 is a cross-sectional view of an ESD protection device having lateral pnp and npn transistors according to conventional art;

FIG. 3 is a cross-sectional view of a low-voltage-triggered SCR (LVTSCR) according to conventional art;

FIG. 4 is a graph of an SCR characteristic curve according to change of an anode voltage in an ESD protection device; and

FIG. 5 is a simplified circuit diagram of an SCR with two terminals.

### DETAILED DESCRIPTION OF EXEMPLARY EMBODIMENTS

Hereinafter, exemplary embodiments according to the invention will be described in detail with reference to the accompanying drawings. The following exemplary embodiments are described so that this disclosure is comprehensive and enabling of practice of the invention by those of ordinary skill in the art. The invention may, however, be embodied in different forms and should not be construed as limited to the exemplary embodiments set forth herein.

In the first exemplary embodiment of the invention, key technical aspects of embodiment of a triple-well low-voltage-triggered ESD protection device are as follows:

First, a method of embodying a silicon controlled rectifier (SCR) for improved electrostatic discharge (ESD) protection of a CMOS chip in a very deep sub-micron (VDSM) process is presented;

Second, a technique of forming a deep well is presented to form a triple-well structure; and

Third, a technique of forming a p+ having a high doping concentration at a junction between an n-type well and a p-type well is presented for inducing faster triggering of the SCR and effectively operating an ESD protection device by an external bias connecting an RC-network.

In order to explain the ESD protection principal of the ESD protection device, the ESD protection principal of the SCR device will be described first.

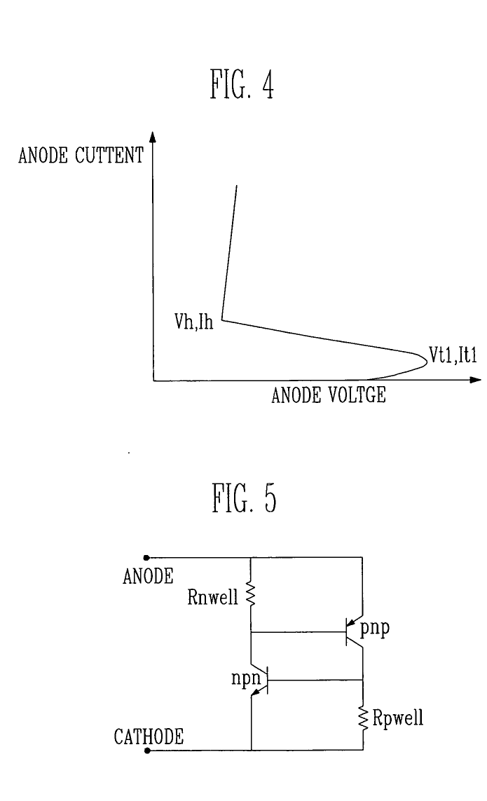

Since a conventional SCR structure may change from a high impedance state to a low impedance state, an ESD protection circuit that is highly effective relative to its area can be made using the SCR structure. FIG. 2 illustrates an SCR structure composed of simple lateral pnp and npn transistors. A p+ diffusion region of the SCR in an n-type well region is connected to an anode, and an n+ diffusion region in a p-type well is connected to a cathode of the SCR. FIG. 4 illustrates an SCR characteristic curve according to change of an anode voltage in such an ESD protection device, and the device's operation principal will be described below.

When the anode voltage is larger than a trigger voltage, a forward bias is applied to an emitter-base junction of the pnp transistor and the pnp transistor is turned on. Current flowing through the pnp transistor flows to the p-type well and, thereby, the npn transistor is turned on. Current of the npn transistor flowing from the n-type well to the cathode holds the forward bias at the pnp transistor, and thus it is not necessary to hold the bias at the pnp transistor, and the anode voltage is reduced to the minimum value, which is called the holding voltage. Then, the SCR performs a positive feedback operation enabling it to effectively discharge an ESD current flowing from the anode.

An SCR with two terminals may be simplified by the circuit of FIG. 5. Here, an Rn-type well (R_{nwell}) and an Rp-type well (R_{pwell}) are resistance values of the n- and p-type wells, each of which provides bias to the respective pnp and npn transistors. When the SCR is in a latch mode, a condition such as Formula 1 should be satisfied to maintain the state.
βₙₚₙ·βₚₙₚ≧1 [Formula 1]

Here, the βₙₚₙ and βₚₙₚ are current gains of the npn and pnp transistors.

When the SCR structure is used as the ESD protection circuit, in order to trigger the protection device, an avalanche breakdown is needed at a junction between the n- and p-type wells. In a VDSM advanced CMOS process, the avalanche breakdown voltage between the n-type well and a p-type substrate is so high (about 20V or more) that the trigger voltage reduced to constitute the ESD protection circuit using the SCR.

In an exemplary embodiment of the invention, a new ESD protection device having an SCR structure with a low trigger voltage is produced by a triple-well process.

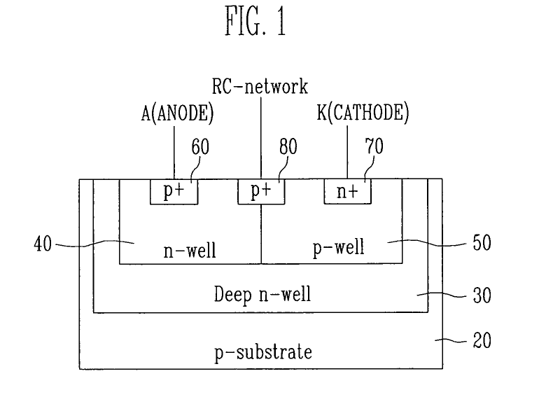

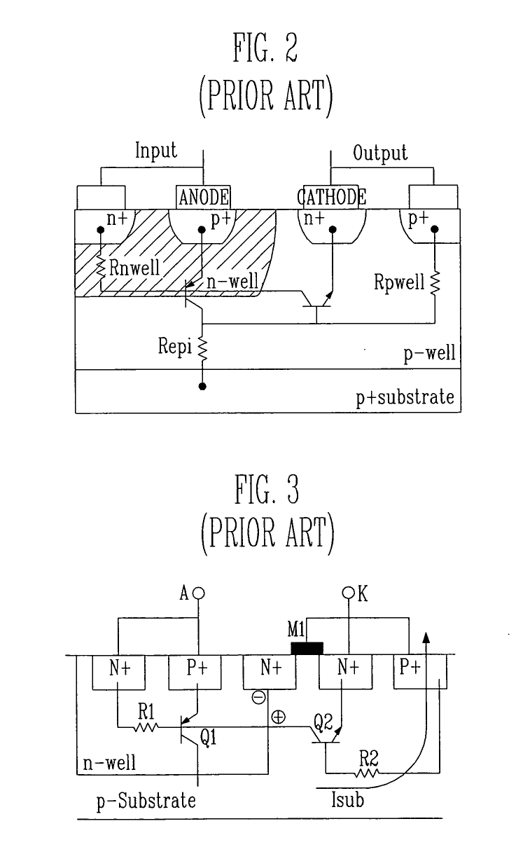

As illustrated in FIG. 1, the ESD protection device comprises: a deep n-type well 30 formed on a p-type substrate 20; n- and p-type wells 40 and 50 formed to be mutually connected in the deep n-type well 30; a p+ diffusion region 60 formed in the n-type well 40 and functioning as an anode; an n+ diffusion region 70 formed in the p-type well 50 and functioning as a cathode; and a p+ diffusion region 80 for an RC-network formed on a junction surface of the n- and p-type wells 40 and 50.

The ESD protection device with the proposed structure has a twin well including the p- and n-type wells 40 and 50 formed after forming the deep n-type well 30 in the p-type substrate 20, and the high-concentration p+ diffusion region 80 formed at the junction between the n- and p-type wells 40 and 50, so as to directly apply bias to the p-type well 50, thereby inducing a much lower trigger voltage. In this case, the p+ diffusion region 60 in the n-type well 40 is connected to an I/O pad as an anode of the SCR and n+ diffusion region 70 in the p-type well 50 is connected to ground as a cathode of the SCR, and thereby an ESD discharge path is provided.

Here, the p+ diffusion region 80 doped with a high concentration is formed between the n- and p-type wells 40 and 50, and when an ESD pulse is input, the bias is directly applied by the RC network connected to the region, thereby inducing forward bias at the junction between the n- and p-type wells 40 and 50. Finally, ESD current introduced through the anode is easily discharged to the cathode. At the same time, the current introduced through the p+ diffusions region 80 raises the potential of the p-type well 50, thereby turning the lateral npn transistor on. The potential of the n-type well 40 is reduced by the npn transistor which is turned on, and thereby the lateral pnp transistor is turned on. As a result, the SCR performs a positive feedback operation and effectively discharges the ESD current.

Structurally, it is possible to make the direct bias applied to the p-type well region 50 which controls the trigger voltage of the SCR by the deep n-type well 30, and thus the protection device may be operated with a lower voltage than the conventional SCR. Also, the junction between the n-and p-type wells 40 and 50 is infused with charge from the high-concentration p+ diffusion region 80 so that the RC network applies positive bias to the p-type well 50. Thereby, a lower trigger voltage and more rapid response speed to the ESD pulse can be obtained. Therefore, the ESD protection circuit produced by this process can be applied to a VDSM-level semiconductor chip with high speed and low voltage, thereby increasing the stability and reliability of the chip.

In another exemplary embodiment of the invention, an ESD protection device comprises: a deep p-type well formed on an n-type substrate; n- and p-type wells formed to be mutually connected in the deep p-type well; a p+ diffusion region formed in the n-type well; an n+ diffusion region formed in the p-type well; and a p+ diffusion region (a bias application region) for an RC network formed on a junction surface of the n- and p-type wells to directly apply bias to the n-type well.

The structure of this ESD protection device is symmetrical with that of the first exemplary embodiment, the only difference being that p- and n-type regions are switched. Expectedly, it has symmetrical operation characteristics to the first exemplary embodiment based on ground voltage, and well suited for application to a semiconductor chip operated by a negative power voltage.

In the case of this ESD protection device, the p+ diffusion region is connected to the ground voltage of the semiconductor chip, and the n+ diffusion region is connected to an I/O pad of the semiconductor chip, so that a large, negative ESD pulse applied to the I/O pad is prevented from flowing into the semiconductor chip. The p+ diffusion region for the RC network which supplies direct bias to an SCR is converted into an n+ diffusion region, and the bias voltage applied thereto is also opposite in sign to that in the first exemplary embodiment.

A triple-well low-voltage ESD protection device having the above configuration may be effectively applied to a semiconductor chip having high-speed and low-voltage characteristics.

The triple-well low-voltage-triggered ESD protection device can minimize parasitic capacitance and/or obtain a rapid response speed with respect to an ESD pulse while being triggered by low trigger voltage.

Also, the ESD protection device with high speed and low voltage can be applied in various fields such as almost all I/O interface circuits based on nano devices, semiconductor integrated circuits, and so forth. And, the semiconductor chip having the protection device built-in is very stable, reliable, and lest costly to produce because it is formed of one chip.

With the rapid advancement of semiconductor processing technology to the VDSM level, a gate oxide layer of an MOSFET is becoming thinner and breakdown of devices due to ESD in a semiconductor chip is becoming a larger problem. As ESD pulses can have a high voltage on the order of kilovolts and a current of Amps, the potential damage they could cause to internal circuit lines in a chip cannot be ignored. Therefore, the importance of an effective ESD protection device capable of being applied to VDSM-level semiconductor chips is increasing. Since a conventional SCR has a high trigger voltage, it cannot be applied to a VDSM-level integrated circuit despite its strong ESD protection capability. Thus, a highly improved SCR protection device with a new structure is proposed.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An electrostatic discharge (ESD) protection device comprising:
a deep n-type well formed on a p-type substrate;
n-type and p-type wells formed to be mutually connected in the deep n-type well; and
a bias application region for directly applying a bias voltage to the p-type well.

2. The device according to claim 1, wherein the bias application region is a p+ diffusion region formed at a junction surface of the n-type and p-type wells.

3. The device according to claim 1, further comprising:
a p+ diffusion region formed in the n-type well; and
an n+ diffusion region formed in the p-type well.

4. The device according to claim 2, further comprising:
a p+ diffusion region formed in the n-type well; and
an n+ diffusion region formed in the p-type well.

5. The device according to claim 3, wherein the p+ diffusion region is connected to an I/O pad, the n+ diffusion region is connected to ground, and a bias voltage of an external RC network is applied to the bias application region.

6. An ESD protection device, comprising:
a deep p-type well formed on an n-type substrate;
n- and p-type wells formed to be mutually connected in the deep p-type well; and
a bias application region for directly applying a bias voltage to the n-type well.

7. The device according to claim 6, wherein the bias application region is an n+ diffusion region formed at a junction surface of the n- and p-type wells.

8. The device according to claim 6, further comprising:
a p+ diffusion region formed in the n-type well; and
an n+ diffusion region formed in the p-type well.

9. The device according to claim 7, further comprising:
a p+ diffusion region formed in the n-type well; and
an n+ diffusion region formed in the p-type well.

10. The device according to claim 8, wherein the n+ diffusion region is connected to an I/O pad, the p+ diffusion region is connected to ground, and a bias voltage of an external RC network is applied to the bias application region.
